(19) United States
(12) Patent Application Publication
(10) Pub. No.: US 2007/0021907 A1
(43) Pub. Date: Jan. 25, 2007

(54) Navigation system

(75) Inventors: Seiji Kato, Toyota-city (JP); Masanori Oumi, Gifu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/489,675

(22) Filed: Jul. 20, 2006

(30) Foreign Application Priority Data
Jul. 21, 2005 (JP) 2005-211383
Jul. 26, 2005 (JP) 2005-216355
Mar. 30, 2006 (JP) 2006-095619

(51) Int. Cl. G01C 21/00

(52) U.S. Cl. 701/207

(57) ABSTRACT

A navigation system is mounted in a vehicle positioned in a facility, whose on-site passage data is unavailable for the system. In this case, the system determines whether a facility exit is learned. When the facility exit is learned, the system defines, as a facility exit coordinates, the learned coordinates. When the facility exit is not learned, the system defines, as the facility coordinates, a guidance coordinates, which is used to terminate a route guidance when the facility is designated as a destination. The system then retrieves a route using the defined facility exit coordinates as a departure position. Even when the on-site passage data is unavailable, defining the facility exit allows the system to highly accurately retrieve a route passing through the actual facility exit.

### CROSS REFERENCE TO RELATED APPLICATIONS

This application is based on and incorporates herein by reference Japanese Patent Applications No. 2005-211383 filed on Jul. 21, 2005, No. 2005-216355 filed on Jul. 26, 2005, and No. 2006-95619 filed on Mar. 30, 2006.

### FIELD OF THE INVENTION

The present invention relates to a navigation system that can search for a route to a destination.

### BACKGROUND OF THE INVENTION

Patent document 1 describes the following system. Facility data contains a position of a facility on a map and a position of a doorway of the facility. The system uses the facility data to determine that a vehicle is currently positioned in the facility. The system extracts coordinate data for all exits in the facility and displays a sub-screen, which shows the current position and exits of the facility around the current position. The system designates an exit nearest to the current position and searches for a detailed route connected to a retrieved route from the nearest exit. The system identifies a direction to the retrieved route from the nearest exit. The system uses the sub-screen to display not only traveling direction guidance to the retrieved route from the nearest exit, but also the detailed route connected to the retrieved route.

Patent Document 1: JP-2005-37275 A

The facility data may not contain the position of a doorway in the facility. In this case, the system does not search for a route passing through the facility exit. Generally, the system retrieves a route from a point on a road adjacent to the facility. The retrieved route may not pass through the actual facility exit. A user thus needs to determine a route from the facility exit to the beginning point of the retrieved route.

Furthermore, the above-mentioned conventional technology merely provides the screen to display a positional relationship between the vehicle's current position and the facility exit. Accordingly, the user cannot easily find which direction the facility exit is located in with reference to the current vehicle orientation (e.g., vehicle's traveling direction).

### SUMMARY OF THE INVENTION

It is an object of the present invention to provide a navigation system capable of highly accurately searching for a route passing through an actual facility exit.

According to an aspect of the present invention, a navigation system in a vehicle is provided as follows. Map data storage means is included for storing map data on a map, the map data including (i) facility data on a position of a facility and a site of the facility and (ii) road data on a road outside the facility. Vehicle position detection means is included for detecting a vehicle position of the vehicle. Point storage means is included for storing, as a certain point, one of (i) an entering point where the vehicle position moves from a road outside the facility into the facility and (ii) an exiting point where the vehicle position moves from within the facility to a road outside the facility. Facility inside determination means is included for determining whether or not the vehicle position is in a facility. Exit designation means is included for, when the vehicle position is determined to be in a facility, designating the certain point stored in the point storage means as an exit, through which the vehicle is able to exit from within the facility to a road outside the facility.

### BRIEF DESCRIPTION OF THE DRAWINGS

FIG. 1 is a block diagram showing an overall construction of a navigation system according to a first embodiment;

FIG. 2 is a block diagram showing major parts of a control function provided for a controller in FIG. 1;

FIG. 3 is a flowchart showing a process performed by route guidance means in FIG. 2;

FIG. 4 is a block diagram showing major parts of a control function provided for a controller according to a second embodiment;

FIG. 5 is a flowchart showing a process performed by route guidance means in FIG. 4;

FIG. 6 illustrates an overview of facility exit guidance according to a third embodiment;

FIG. 7 illustrates a facility exit guidance point designated based on an on-site road according to the third embodiment;

FIG. 8 illustrates a facility exit guidance point designated based on a virtual on-site road according to the third embodiment;

FIG. 9A shows angle θ of a facility exit direction against a vehicle orientation according to the third embodiment;

FIG. 9B is a diagram listing relationship between angle θ and a facility exit direction according to the third embodiment;

FIG. 10 is a flowchart showing a facility exit guidance process according to the third embodiment;

FIG. 11 is a flowchart showing a virtual node setup process according to the third embodiment;

FIG. 12 is a flowchart showing a first half of the facility exit guidance process according to a fourth embodiment;

FIG. 13 is a flowchart showing a second half of the facility exit guidance process according to the fourth embodiment;

FIG. 14 is a flowchart showing a slope entry point guidance process according to the fourth embodiment; and

FIG. 15 is a flowchart showing an exit direction guidance process according to the fourth embodiment.

### DETAILED DESCRIPTION OF THE PREFERRED EMBODIMENTS

### First Embodiment

A navigation system 100, as an example of embodiments of the invention will be described with reference to the accompanying drawings.

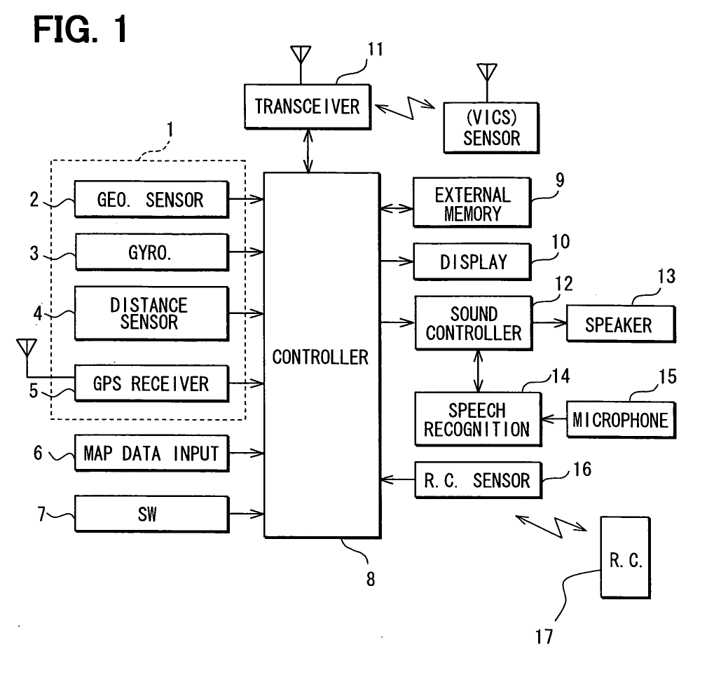

As shown in FIG. 1, the navigation system 100 includes a position detector 1, a map data input device 6, an operation switch group 7, an external memory 9, a display device 10, a transceiver 11, a sound controller 12, a speaker 13, a speech recognition device 14, a microphone 15, a remote control sensor 16, a remote controller 17, and a controller 8 connecting these devices.

The controller 8 is an ordinary computer. The controller 8 contains a known CPU, ROM, RAM, I/O, and a bus line to connect these components. The ROM contains a program executed by the controller 8. Following this program, the CPU and the like perform arithmetic operations.

The position detector 1 includes a geomagnetic sensor 2, a gyroscope 3, a distance sensor 4, and a GPS (Global Positioning System) receiver 5. The geomagnetic sensor 2 detects a vehicle's absolute orientation. The gyroscope 3 detects a vehicle's relative orientation. The distance sensor detects a vehicle's traveling distance. The GPS receiver is used for the global positioning system that measures vehicle positions based on radio waves from satellites. These sensors and the like 2, 3, 4, and 5 comply with known technologies. Each of the sensors and the like 2, 3, 4, and 5 contains a differently characterized error. The multiple sensors and the like 2, 3, 4, and 5 are used to complement each other. Depending on accuracies, part of the above-mentioned devices may construct the position detector 1. Further, it may use a revolution sensor for a steering wheel, vehicle speed sensors for rolling wheels, and the like (non shown).

The map data input device 6 is provided with a storage medium such as DVD-ROM or CD-ROM, for example. The storage medium stores digital map data including road data, background data, text data, and facility data. These data are supplied to the controller 8.

The road data includes link data and node data. A node is defined to be a point to intersect, fork, and merge roads on the map. A link is defined to be a line between nodes. Connecting links constitute a road. The link data contains a unique number (link ID) to specify the link; a link length to indicate the length of the link; node coordinates (e.g., latitude and longitude) to indicate the beginning and end of the link; a road name; a road type categorized as toll road such as express highway, general road (national road and local road belonging to prefecture, city, village, etc.), and on-site road; a road width; and the like.

The link data also contains links for roads within parking areas provided in some facilities (e.g., large facilities such as theme parks and shopping malls) on the map. The link is assigned the road type of on-site road.

The node data includes a node ID, a node coordinates, a node name, a connection link ID, and a connection angle between connection links. The node ID is a unique number assigned to each node where a road intersects, merges, or forks on the map. The connection link ID describes link IDs for all links connected to the nodes.

The facility data is used to search for facilities and the like. The facility data includes various data such as a name, a type, and a coordinates indicating a facility position. For example, given facility data may match a large facility such as theme park and shopping mall and may be equivalent to an area greater than or equal to a designated site area. Such facility data is provided with coordinates to specify a site size. For example, a rectangular facility is provided with several vertex coordinates along the diagonal line.

The facility data contains a representative coordinates of the facility, a guidance coordinates, and area data. This guidance coordinates is defined as a point at which a route guidance terminates when the facility is designated as a destination. Generally, the guidance coordinates is equivalent to a facility entry coordinates. The area data is also referred to as polygon data and includes a set of polygons that form a closed loop to enclose an area (range) of the facility. With respect to some facilities, the facility data includes multiple links and nodes to represent a passage in the facility (e.g., a passage for a parking area in the facility), and at least one of the multiple nodes contains on-site passage data defined as a facility exit.

The operation switch group 7 includes touch switches integrated with the display device 10 or mechanical switches provided around the display device 10. The operation switch group 7 is used for various input operations such as changing the reduction of a map displayed on the display device 10, selecting a menu display, setting a destination, starting the route guidance, modifying the current position, changing the display screen, and adjusting the sound volume. The remote controller 17 is provided with multiple operation switches (not shown). Operating these operation switches is equivalent to input operations on the operation switch group 7. Operating the remote controller 17 generates a signal representing the input operation. This signal is supplied to the controller 8 via the remote control sensor 16.

The external memory 9 is a storage device and is available as a memory card, a hard disk, and the like. The external memory 9 is provided with a writable storage medium. The external memory 9 stores user-entered his or her home position and various types of data such as text data, image data, and sound data.

The external memory 9 also stores a driving log that provides a history of vehicle positions detected by the position detector 1. The external memory 9 chronologically writes coordinate data for vehicle positions. The external memory 9 may additionally write a link ID and a node ID as well as the coordinate data. When the amount of stored data reaches a designated limit, new data overwrites the existing data from the earliest.

The display device 10 is available as a liquid crystal display or an organic EL display, for example. The display device 10 has a predetermined map display area. This area displays a vehicle position mark corresponding to the vehicle's current position on a road map near the vehicle in an overlapping manner. The road map is generated from the map data. The display device 10 can also display additional information such as the current time and the congestion information.

The transceiver 11 is a communication device to provide communication connection with the outside. The transceiver 11 is connected to a VICS sensor. The VICS sensor receives information from a VICS (Vehicle Information and Communication System) (registered trademark) center via beacons installed on roads and local FM broadcasting stations. The VICS center provides the road traffic information including weather information, date information, facility information, and advertisement information. The transceiver 11 transmits this road traffic information to the controller 8. The transceiver 11 can also output information processed in the controller 8.

Based on a sound output signal supplied from the sound controller 12, the speaker 13 externally outputs sounds (such as sounds for guidance, explanation on screen operations, and speech recognition result).

The microphone 15 supplies the speech recognition device 14 with the speech uttered by an operator in the form of an electric signal. The speech recognition device 14 collates the operator's input speech supplied from the microphone 15 with vocabulary data (comparison pattern) in an internally stored recognition dictionary (not shown). The speech recognition device 14 supplies highly possibly matching data as a recognition result to the sound controller 12.

The sound controller 12 controls the speech recognition device 14. In addition, the sound controller 12 controls talk-back output (sound output) using the speaker 13 for the operator that supplied the speech input. The sound controller 12 also supplies the controller 8 with the recognition result from the speech recognition device 14.

The navigation system 100 has a so-called route guidance function. When the user designates a destination using the operation switch group 7 or the remote controller 17, the system automatically retrieves an optimal route from the current position (or a user-designated point) as a departure position to the destination. The system displays the retrieved route on the screen and guides the user to the destination. The technique to automatically find an optimal path uses a cost calculation method according to the known Dijkstra algorithm, for example.

The controller 8 mainly implements these functions by performing various processes. When a destination is designated, the controller 8 searches for a route using the map data on the map data input device 6. The controller 8 displays the retrieved route on the display device 10. The controller 8 also enlarges the map or provides a sound guidance at a branching point or an intersection to turn to the right or left.

Based on information from the speech recognition device 14, the controller 8 performs designated processes in accordance with the operator's speech and operations on the operation switch group 7 or the remote controller 17. For example, these processes include storing map data on the external memory 9, changing the map reduction, selecting menu displays, setting the destination, retrieving routes, starting the route guidance, modifying the current position, changing the display screen, and adjusting the sound volume.

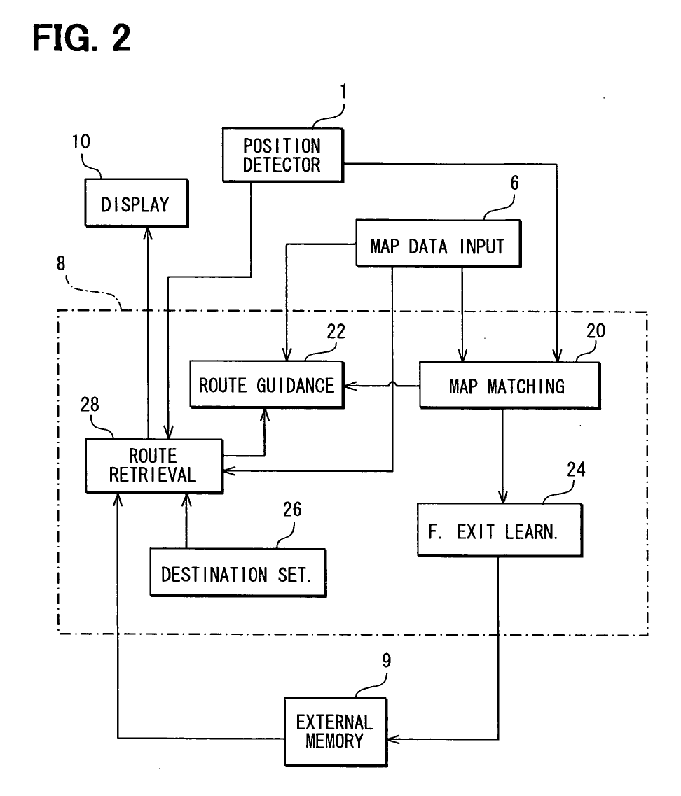

FIG. 2 is a block diagram showing major parts of a control function provided for the controller 8. As shown in FIG. 2, the controller 8 has map matching means 20, route guidance means 22, facility exit learning means 24, destination setting means 26, and route retrieval means 28.

The map matching means 20 determines a vehicle position coordinates based on a signal detected by the position detector 1. Based on the determined vehicle position coordinates, the map matching means 20 reads map data around the vehicle position from the map data input device 6. The map matching means 20 compares the vehicle position coordinates with road data contained in the map data and area data in the facility data. In this manner, the map matching means 20 periodically determines on which road in the map data or in which facility the vehicle is positioned. The map matching means 20 compares a shape of a vehicle's swept path with a road shape around the vehicle position. The map matching means 20 assumes the road most associated with the swept path to be the road where the vehicle is traveling. In this manner, the map matching means 20 also corrects the vehicle position coordinates determined based on the signal from the position detector 1.

When the map matching means 20 determines the map data around the vehicle position, the route guidance means 22 reads this map data from the map data input device 6. In addition, the route guidance means 22 compares the vehicle position on the read map data with the route retrieved by the route retrieval means 28 to perform a route guidance.

The map matching means 20 determines that the vehicle coordinates changes from being inside the facility to being on the road. At this time, the facility exit learning means 24 stores the coordinates as a coordinates of the facility exit in the external memory 9.

The destination setting means 26 displays a designated destination setup screen on the display device 10. Alternatively, the destination setting means 26 allows the speaker 13 to generate a designated sound prompting the user to set the destination. The user designates a point by operating the operation switch group 7 or the remote controller 17 or vocally using the microphone 15. The destination setting means 26 defines the designated point as the destination.

When the user designates a departure position, the route retrieval means 28 retrieves one or more routes from the departure position to the destination defined by the destination setting means 26. To do this, the route retrieval means 28 uses a known technique such as the Dijkstra algorithm, as explained above, based on the map data supplied from the map data input device 6. The route retrieval means 28 displays the retrieved routes on the display device 10.

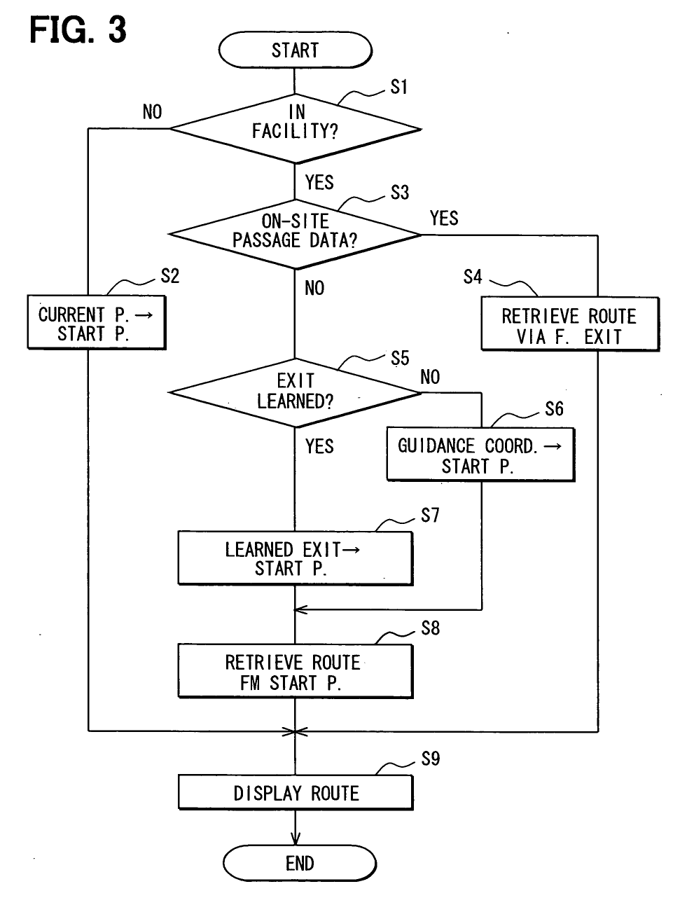

The user may designate no departure position. Alternatively, the current position may be designated as a departure position. In such case, the route retrieval means 28 performs a process in FIG. 3 to retrieve a route to the destination determined by the destination setting means 26.

At Step S1 in FIG. 3, the process determines whether or not the vehicle's current position is inside a facility. When the result of the determination at Step S1 is negative, the process assumes the current position to be a departure position at Step S2. The process retrieves one or more routes from the departure position to a destination using a technique similar to that used when the user designates a departure position.

When the vehicle's current position is inside the facility (the result of Step S1 is affirmative), the current position may not be found on links in the map data and able to be designated as the departure position. The process proceeds to Step S3 and later.

At Step S3, the process determines whether or not facility data for the facility contains on-site passage data. When the result of the determination at Step S3 is affirmative, the process proceeds to Step S4 to trace links of the on-site passage data and determine a route to the node defined as the facility exit. Similarly to Step S2 above, the process retrieves a route from the node (facility exit) to the destination.

When the facility data does not contain the on-site passage data, the result of the determination at Step S3 becomes negative. In this case, the process proceeds to Step S5 to determine whether or not the external memory 9 stores the coordinates of the facility exit learned by the above-mentioned facility exit learning means 24.

When the result of the determination at Step S5 is negative, the process proceeds to Step S6. When there is a guidance coordinates included in the facility data of the facility where the vehicle is currently positioned, the process determines this guidance coordinates to be the coordinates of the facility exit. The process then performs Step S8. As mentioned above, the facility entry generally has a predetermined coordinates and the facility entry is also used as an exit. The facility's guidance coordinates relatively accurately represents the facility exit coordinates.

When the result of the determination at Step S5 is affirmative, the process determines the learned coordinates to be the facility exit coordinates at Step S7. At Step S8, the process uses the facility exit coordinates determined at Step S6 or S7 as the departure position. That is, the process retrieves a route to the destination similarly to Step S2 or S4 so as to pass through the facility exit coordinates.

After performing any of Steps S2, S4, and S8, the process displays a retrieved route on the display device 10 at Step S9.

Thus, the above-mentioned embodiment positively determines a facility exit at Step S4, S7, or S6 in a priority order when the vehicle is positioned in a facility, as follows. (i) On-site passage data to able to determine a node as a facility exit may be available for the corresponding facility. In this case, at Step S4, a route to the node defined as the facility exit and a route from the facility exit to a destination are retrieved. (ii) When on-site passage data is not available, the external memory 9 may store the facility exit learned by the facility exit learning means 24. In this case, the facility exit learned by the facility exit learning means 24 is determined to be the facility exit at Step S7. (iii) There may be a case where no on-site passage data is available and the facility exit learned by the facility exit learning means 24 is not stored. In this case, a guidance coordinates assigned to the facility is determined to be the facility exit at Step S6. Furthermore, at Step S8, the facility exit determined at Step S7 or S6 is used as the departure position and a route is then retrieved to a destination so as to pass through the facility exit. Thus, the embodiment can highly accurately retrieve a route passing through the actual facility exit.

### Second Embodiment

A second embodiment of the invention will be described below. In the following description, the components common to the first embodiment are depicted by the same reference numerals and a detailed description is omitted for simplicity.

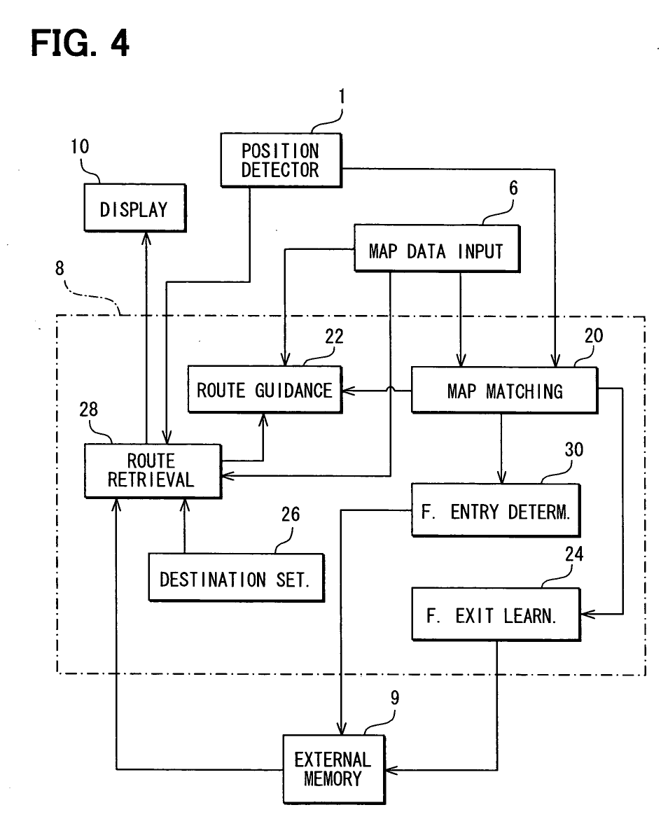

A navigation system 100 according to the second embodiment has the construction as shown in FIG. 1 but differs from the first embodiment in control contents of a controller 8. FIG. 4 is a block diagram showing major parts of a control function provided for the controller 8 according to the second embodiment. The controller 8 according to the second embodiment differs from the first embodiment in addition of facility entry determining means 30.

A map matching means 20 may determine that a vehicle coordinates changes from being on the road to being in the facility. The facility entry determining means 30 determines the coordinates at this point to be the coordinates of the facility entry. The facility entry determining means 30 stores the determined facility entry coordinates in the external memory 9.

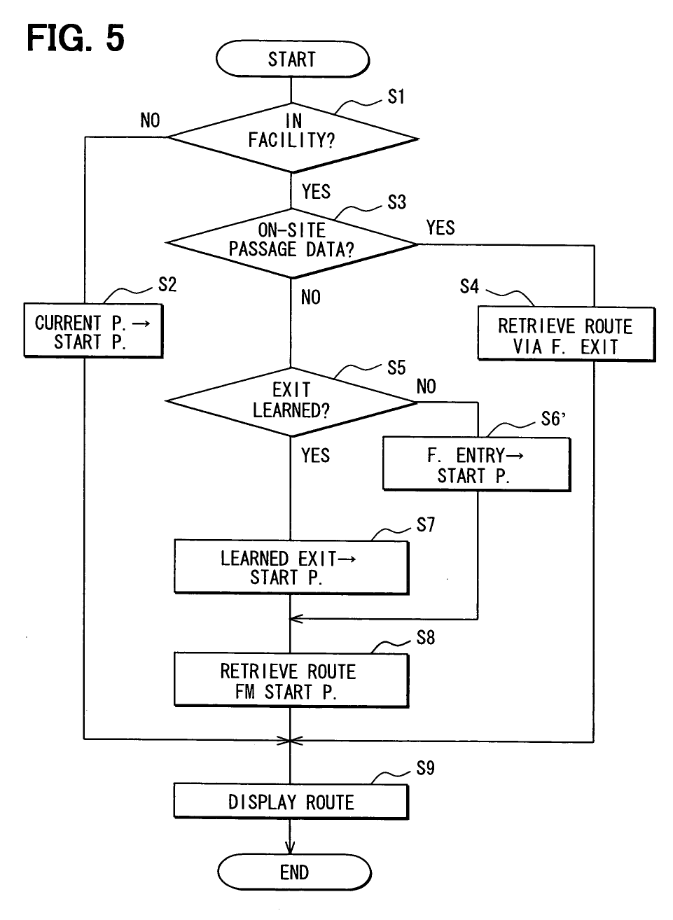

FIG. 5 is a flowchart showing a process performed instead of the process in FIG. 3 according to the second embodiment when a route guidance means 22 according to the second embodiment satisfies the same condition as in FIG. 3.

The flowchart in FIG. 5 differs from that in FIG. 3 only in that Step S6′ is performed instead of Step S6. Step S6′ is performed when the current position is in the facility (YES at Step S1), there is no on-site passage data (NO at Step S3), and no facility exit is learned (NO at Step S5).

When the facility entry determining means 30 determines a facility entry coordinates, Step S6′ determines this coordinates to be the facility exit coordinates. Step S6′ is performed when the result of Step S1 is affirmative, i.e., when the current position is in the facility. When the Step S6′ is performed, the facility entry coordinates is always determined. The facility entry is often used as an exit. The facility entry coordinates relatively accurately represents the facility exit coordinates.

Thus, the above-mentioned embodiment positively determines a facility exit at Step S4, S7, or S6′ in a priority order when the vehicle is positioned in a facility, as follows. (i) On-site passage data to able to determine a node as a facility exit may be available for the corresponding facility. In this case, at Step S4, a route to the node defined as the facility exit and a route from the facility exit to a destination are retrieved. (ii) When on-site passage data is not available, the external memory 9 may store the facility exit learned by the facility exit learning means 24. In this case, the facility exit learned by the facility exit learning means 24 is determined to be the facility exit at Step S7. (iii) There may be a case where no on-site passage data is available and the facility exit learned by the facility exit learning means 24 is not stored. In this case, a facility entry is automatically determined when the vehicle enters the facility and this automatically determined facility entry is determined to be the facility exit at Step S6′. Furthermore, at Step S8, the facility exit determined at Step S7 or S6′ is used as the departure position and a route is then retrieved to a destination so as to pass through the facility exit. Thus, the embodiment can highly accurately retrieve a route passing through the actual facility exit.

Modifications to the First and Second Embodiments

The first and second embodiments can be modified as follows.

According to the above-mentioned embodiments, for example, the facility data about some facilities contains on-site passage data. On the other hand, the facility data about all facilities may be void of on-site passage data. When the facility data about all facilities is void of on-site passage data, Steps S3 and S4 are omitted from FIG. 3 or 5. Also in this case, Step S6 or S6′ can positively determine the facility exit even when the facility exit is not learned (S5: NO). Alternatively, the facility exit may be learned (S5: YES). In this case, the process retrieves a route passing through the facility exit preferentially using the learned facility exit (Step S7). The embodiment can highly accurately retrieve a route passing through the actual facility exit.

The facility exit learning means 24 may be omitted from the above-mentioned embodiments. When the facility exit learning means 24 is omitted, Steps S5 and S7 are omitted from FIG. 3 or 5. Also in this case, Step S6 or S6′ can positively determine the facility exit. When on-site passage data is available, it is possible to retrieve a route passing through the facility exit by following links of the on-site passage data (Step S4). Accordingly, a route passing through the actual exit can be retrieved highly accurately.

The facility data about all facilities may exclude on-site passage data. In addition, the facility exit learning means 24 may be omitted. Also in this case, Step S6 or S6′ can positively determine the facility exit. Accordingly, a route passing through the actual exit can be retrieved highly accurately.

Step S6 can be omitted from the first embodiment. Step S6′ can be omitted from the second embodiment. When the result of Step S5 is negative, omitting Step S6 or S6′ assumes a point on the road adjacent to the facility to be the starting point as conventionally practiced. Even in this case, when the facility exit is learned or on-site passage data is available, a route passing through the facility exit can be retrieved. It is possible to retrieve a route passing through the actual facility exit more accurately than ever before.

When the facility data about all facilities is void of on-site passage data, it is also possible to omit Step S6 from the first embodiment or Step S6′ from the second embodiment. Also in this case, the facility exit learned by the facility exit learning means 24 is considered to highly accurately represent the actual facility exit. When the facility is visited at the second time or later, it is possible to highly accurately retrieve a route passing through the actual facility exit.

### Third Embodiment

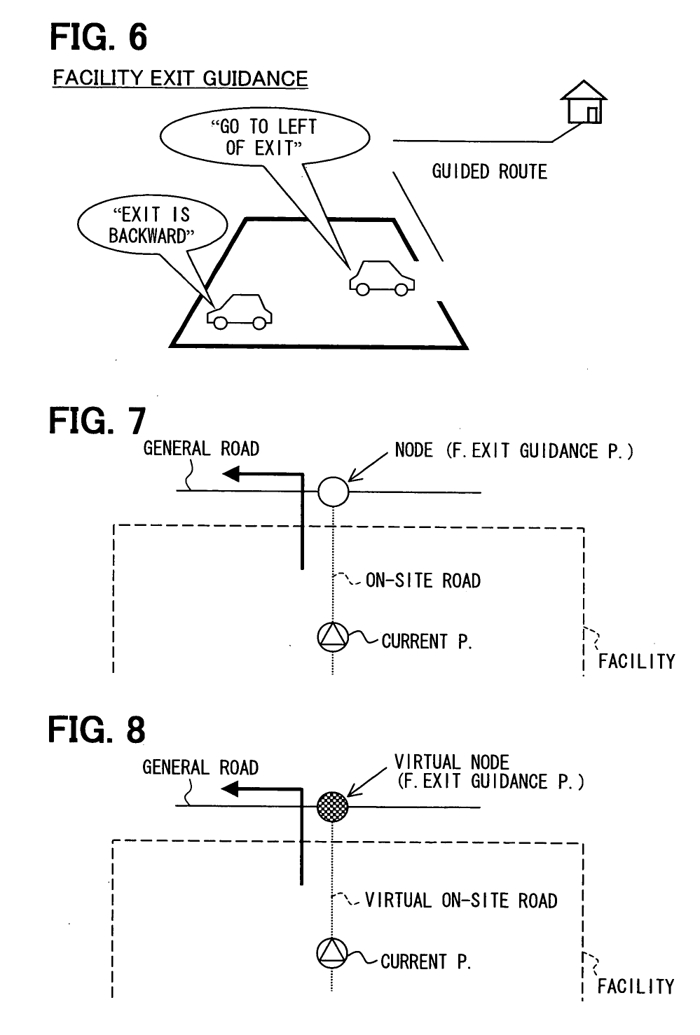

A navigation system 100 in a vehicle according to a third embodiment has the construction in FIG. 1 similarly to the above-mentioned embodiments. As shown in FIG. 6, the navigation system 100 according to the third embodiment has a facility exit guidance function or process. When the vehicle is in the facility, the facility exit guidance function announces the facility's exit direction (e.g., “the exit is backward”) or its exit direction (e.g., “the exit is to the east”). When the vehicle approaches the exit, the facility exit guidance function announces the direction from the exit to a guided route (e.g., “go to the left of the exit”).

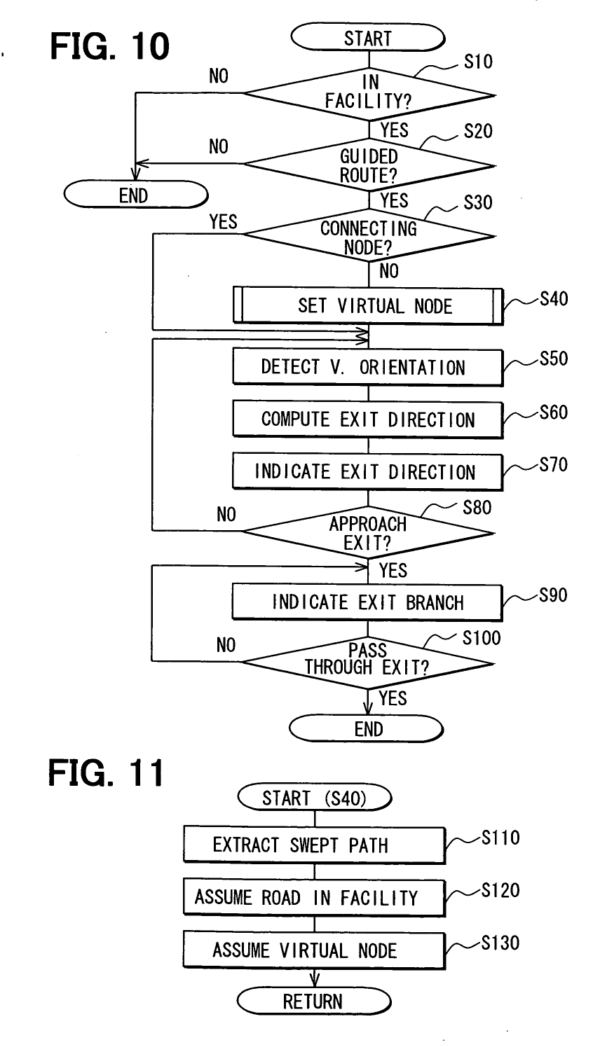

Referring now to flowcharts in FIGS. 10 and 11, the facility exit guidance process will be described. The process starts when the navigation system 100 is turned on. After completing initialization, the process, at Step S10 in FIG. 10, determines whether or not the vehicle is positioned in a facility. This vehicle position may be determined from a coordinates in the most recent log about the vehicle stored in the external memory 9 or from a vehicle position coordinates detected by the position detector 1. When the result of the determination is affirmative, the process proceeds to Step S20. When the result of the determination is negative, the vehicle is assumed to be outside a facility. The process terminates.

At Step S20, the process determines either of (i) whether a route to a destination from a road outside a facility where the vehicle is positioned is retrieved and a route guidance for the retrieved route (or guided route) therefore starts when the vehicle exits from the facility to the road or (ii) whether a route guidance starts from an inside of the facility. When the result of either determination is affirmative, the process proceeds to Step S30. When the result of both determinations is negative, the process terminates. In this manner, the facility exit guidance process is performed when the route guidance is ready to start.

At Step S30, the process determines whether or not there is available a node connecting between a road in the facility where the vehicle is positioned and the road outside the facility. As mentioned above, the navigation system 100 according to the embodiment contains, as link data, links for roads within parking areas provided in some facilities (e.g., large facilities such as theme parks and shopping malls) on the map. The facility data for such facilities is provided with coordinates that designate the site size. A road type of on-site road may be therefore assigned to a road in the facility where the vehicle is positioned. Such road can be determined to belong to an inside of the facility.

Let us suppose that the road type of on-site road is assigned to links of a road in the facility where the vehicle is positioned. As shown in FIG. 7, the on-site road is assumed to be an entering road. The general road outside the facility is assumed to be an exiting road. The process determines whether or not there is a node to connect both roads. When the result of the determination is affirmative, the process assumes the node to be a facility exit guidance point and proceeds to Step S50. When the result of the determination is negative, the process proceeds to Step S40.

When there is available road data about not only the road outside the facility, but also the road inside the facility, the embodiment can specify the node for connecting between links of the road outside the facility and links of the road inside the facility. This node is used as an exit point where the vehicle can exit from the road in the facility where the vehicle is positioned to the road outside the facility.

At Step S40, the virtual node setup process is performed. This process is performed when there is no link for the road in the facility where the vehicle is positioned. The process designates a connection point for connecting the road outside the facility and the road inside it based on a vehicle's swept path traveled by the vehicle from the road outside the facility to the facility. When the vehicle departs from the road outside the facility and enters the facility, the departing point can be determined to be a doorway point (or entry/exit point) of the facility. Accordingly, a virtual node can result from the point where the vehicle's swept path departs from the link or node of the road outside the facility.

At Step S110 as shown in FIG. 11, the process extracts a vehicle's swept path from the external memory 9. The vehicle's swept path ranges from the general road outside the facility to the parking position in the facility. At Step S120, the process virtually assumes a road in the facility from the vehicle's swept path. This virtual road is referred to as a virtual on-site road. Further, the vehicle's swept path departs from the link or node of the general road outside the facility at a given point. At Step S130, the process assumes this point to be a virtual node.

As shown in FIG. 8, the virtual on-site road designated in the facility is assumed to be an entering road. The general road outside the facility is assumed to be an exiting road. The point (the above-mentioned departing point) for connecting both roads is defined as the virtual node. At Step S130, the process assumes the virtual node to be the facility exit guidance point.

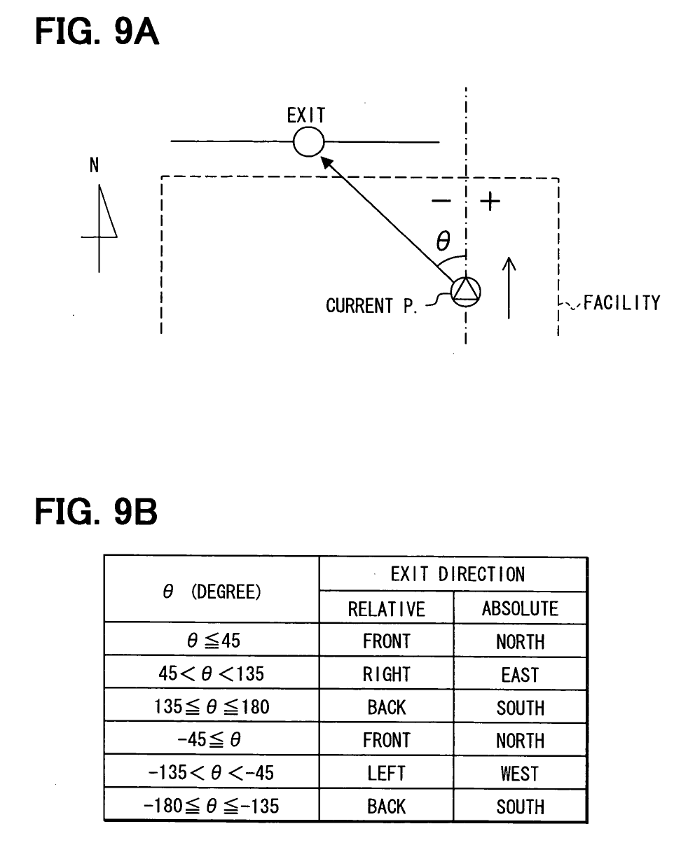

At Step S50 in FIG. 10, the process detects the vehicle position and vehicle orientation (vehicle's traveling direction). At Step S60, the process calculates the facility's exit direction against the vehicle's traveling direction. The facility exit is equivalent to the facility exit guidance point defined at Step S30 or S40. Using the vehicle's current position as a reference as shown in FIG. 9A, the process calculates a relative direction of the facility exit with reference to the vehicle's traveling direction. When the vehicle orientation and the facility exit direction form angle θ, for example, there is previously provided a table listing relationship between angle θ and a facility exit direction, as shown in FIG. 9B. This table may be used to determine the exit direction with reference to the calculated angle θ.

At Step S60 as mentioned above, the process calculates the relative direction of the facility exit against the vehicle's traveling direction. If possible, it may be preferable to calculate the absolute direction of the facility exit. As shown in FIG. 9A, for example, the vehicle position and the absolute direction are detected. In this case, the absolute direction of the facility exit may be determined based on the positional relationship between the vehicle position and the facility exit.

At Step S70, the process outputs a message using a screen display on the display device 10 or audio (e.g., “the exit is backward” or “the exit is to the south.”) This aims at notifying the user of the exit direction (relative or absolute direction) calculated at Step S60. In this manner, the process guides the user in the relative or absolute direction of the facility exit with reference to the vehicle's traveling direction. The user can easily find which direction the facility exit is positioned in.

At Step S80, the process determines whether or not the vehicle approaches the facility exit guidance point. For example, the process determines whether or not the distance between the vehicle position and the facility exit guidance point reaches a designated distance. When the result of the determination is affirmative, the process proceeds to Step S90. When the result of the determination is negative, the process returns to Step S50 and repeats the succeeding steps.

At Step S90, the process performs an exit branch guidance before the vehicle departs from the facility exit guidance point. This guidance provides the direction toward a guided route for which the guidance is available. In FIG. 7 or 8, for example, a guided route exists to the left of the facility exit guidance point. In this case, the process outputs a message using a screen display on the display device 10 or audio (e.g., “go to the left of the exit.”) In this manner, the user can recognize in which direction to go when exiting from the facility to the road outside the facility.

At Step S100, the process determines whether or not the vehicle passes through the facility exit guidance point. When the result of the determination is affirmative, the process terminates. When the result of the determination is negative, the process returns to Step S90 and repeats the subsequent steps until the vehicle passes through the facility exit guidance point.

In this manner, the navigation system 100 according to the embodiment designates a connection point that connects between the road outside the facility and the road in the facility. The system guides the relative or absolute direction of the connection point with reference to the vehicle's traveling direction. Even though the facility data does not contain the facility's doorway position, the system can designate a connection point equivalent to the doorway of the facility where the vehicle is positioned. The user can easily recognize in which direction the connection point such as a doorway point is positioned with reference to the current vehicle orientation.

Modifications

For example, the facility exit guidance process according to the embodiment is performed when the route guidance is ready to start (when the result of the determination at Step S20 in FIG. 10 is affirmative). Even when the route guidance is not ready to start, it may be preferable to notify the user of only the exit direction without a facility exit branch.

The virtual node setup process in FIG. 11 defines the virtual node and assumes it to be the facility exit guidance point. The virtual node is a point where the vehicle departs from the road outside the facility and enters the facility. Though the virtual node is surely an entry point into the facility, it is not guaranteed to be an exit point where the vehicle can exit from the facility to the road outside the facility.

To solve this problem, the following may be performed. After defining the departing point, the system checks for a vehicle's swept path the vehicle travels from the inside of the facility to the road outside the facility. Based on the vehicle's swept path, the system defines a return point where the vehicle's swept path returns to the road outside the facility. The system defines the connection point and the return point and then provides the guidance at the next time or later. This makes it possible to determine whether or not the connection point and the return point match. Accordingly, incorrect guidance can be prevented.

When the departing point differs from the return point, the system may guide the return point direction. When the facility is provided with an entry-only gate or an exit-only gate, for example, the facility entry differs from the exit. Therefore, the departing point differs from the return point. When the departing point differs from the return point, the return point direction can be accurately determined to be the facility's exit direction.

### Fourth Embodiment

A fourth embodiment has much in common with the third embodiment. The following omits detailed description about the common points and mainly describes differences. The facility exit guidance process in a navigation system 100 according to the fourth embodiment differs from the third embodiment as follows. The process determines initiation of the facility exit guidance according to vehicle states such as a parking brake and a shift position. The process indicates a name of an exit area from the facility. When the vehicle is positioned at a multi-level parking structure, the process provides the guidance specific to the multi-level parking structure.

The map data used for the navigation system 100 according to the embodiment contains area signpost data and administrative district data. The area signpost data concerns an area signpost installed on a road and includes a name of an area indicated on the area signpost and a position of the installation. The administrative district data includes a position of a boundary for a administrative district and a name of the administrative district.

The facility data is provided with parking area data about a parking area provided in the facility. The parking area data includes type data, approach road data, and parking area map data. The type data indicates a single-level parking area or a multi-level parking structure.

The approach road data belongs to link data assigned with the road type of on-site road. The approach road data is represented by this type of link data for a road to approach each floor in a multi-level parking structure and by node data connecting the link.

For example, let us consider an approach road for approaching the second floor from the first floor. The approach road data includes links and nodes constituting the approach road, corresponding IDs, a connection sequence (e.g., link (LN) 1->node (ND) 1->LN2->ND2->LN3->ND3->LN4), and data indicating an approach road direction between floors (e.g., 1F->2F).

The parking area map data is polygon data for displaying a parking area map that indicates a parking space, the above-mentioned approach road, and the like in the parking area. A multi-level parking structure is provided with polygon data corresponding to each floor. Further, parking area floor number data is added to indicate which floor the parking area belongs to.

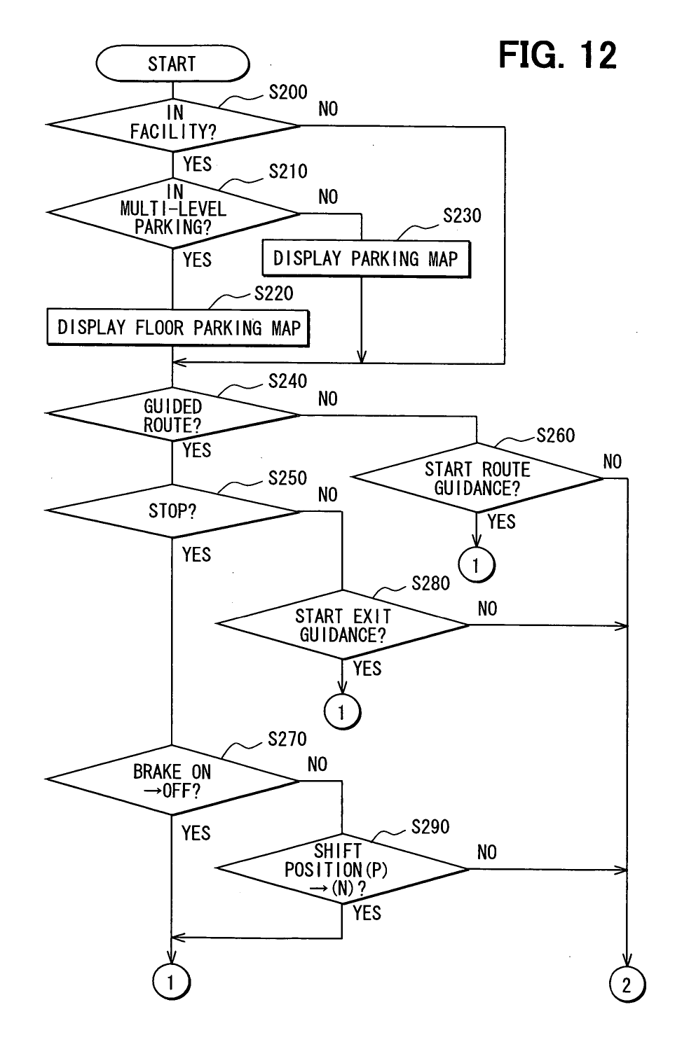

Referring now to flowcharts in FIGS. 12 through 15, the following describes the facility exit guidance process of the navigation system 100 according to the embodiment. The process starts when the navigation system 100 turns on. Upon completion of initialization, the process determines at Step S200 in FIG. 11 whether or not the vehicle is positioned in a facility.

This vehicle position may be determined from a coordinates in the most recent log about the vehicle stored in the external memory 9 or from a vehicle position coordinates detected by the position detector 1. When the result of the determination at Step S200 is affirmative, the process proceeds to Step S210. When the result of the determination is negative, the process proceeds to Step S240.

At Step S210, the process references the type of the above-mentioned parking area data and determines whether or not the vehicle is positioned in a multi-level parking structure. When it is determined that the vehicle is positioned in a multi-level parking structure, the process proceeds to Step S220. When it is determined that the vehicle is positioned in a single-level parking area, the process uses parking area map data at Step S230 to display a parking area map for the single-level parking area where the vehicle is positioned.

At Step S220, the process compares the vehicle's driving log with the approach road data at the vehicle position in the facility to specify the number of a floor where the vehicle is positioned. The process uses the display device 10 to display the floor number of the multi-level parking structure where the vehicle is positioned and the parking area map corresponding to the floor number. Thus, when the vehicle is positioned in the multi-level parking structure, the embodiment designates the floor number corresponding to the vehicle position and displays that floor number. In this manner, a user can recognize which floor the vehicle is positioned at.

At Step S240, the process determines whether or not to already retrieve the route to the destination from the road outside the facility where the vehicle is positioned and whether or not the route guidance is ready to start when the vehicle exits from the facility to the outside road (i.e., whether or not a guided route exists). When the result of the determination is affirmative, the process proceeds to Step S250. When the result of the determination is negative, the process determines at Step S260 whether or not the route guidance is ready to start from the inside of the facility where the vehicle is positioned (i.e., whether or not a new destination is set to start the route guidance). When the result of the determination is affirmative, the process proceeds to Step S300. When the result of the determination is negative, the process terminates without starting the facility exit guidance.

At Step S250, the process determines whether the vehicle stops or is running. When the vehicle is determined to stop, the process proceeds to Step S270. When the vehicle is determined not to stop (the vehicle is running), the process proceeds to Step S280.

At Step S270, the process determines whether the vehicle's parking brake changes from the ON state to the OFF state. When the result of the determination is affirmative, the process proceeds to Step S300. When the result of the determination is negative, the process proceeds to Step S290. At Step S290, the process determines whether the vehicle's shift position changes from parking (P) to a position (reverse (R), drive (D), and the like) other than neutral (N). When the result of the determination is affirmative, the process proceeds to Step S300. When the result of the determination is negative, the process terminates without starting the facility exit guidance.

When the vehicle stops, the process according to the embodiment detects movement from the vehicle's immobile state according to the vehicle state (parking brake and/or shift position) at Steps S270 and S290. When detecting the vehicle movement, the process starts the facility exit guidance. In this manner, the facility exit guidance can start in interlock with the vehicle movement from the immobile state.

When the vehicle is determined to be running at Step S250, the process determines at Step S280 whether or not the user operates the operation switch group 7 to start the facility exit guidance. When the result of the determination is affirmative, the process proceeds to Step S300. When the result of the determination is negative, the process terminates without starting the facility exit guidance.

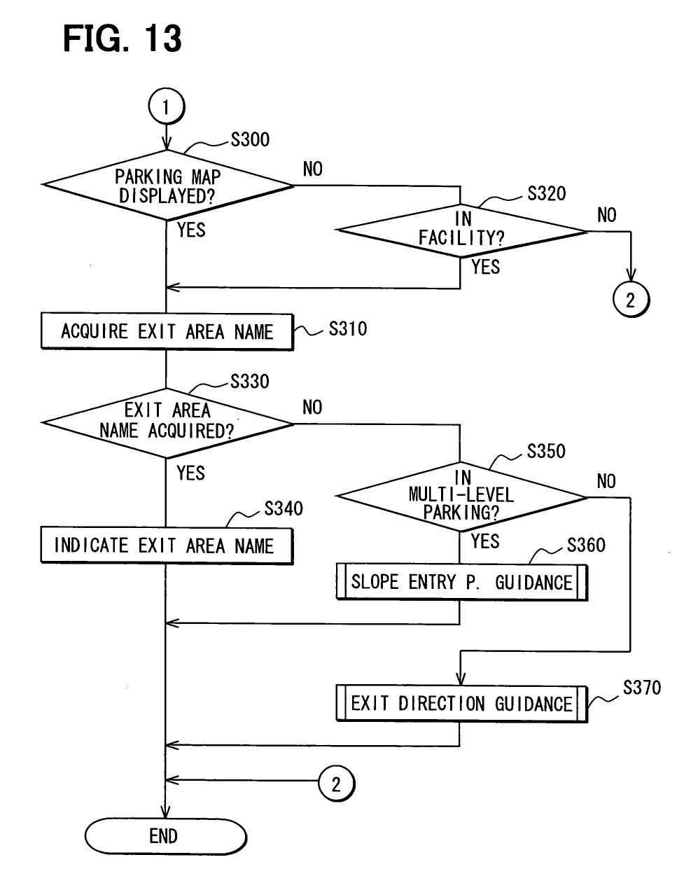

At Step S300 in FIG. 13, the process determines whether or not the display device 10 displays the parking area map. When the result of the determination is affirmative, the process proceeds to Step S310. When the result of the determination is negative, the process proceeds to Step S320. At Step S320, the process determines whether or not the vehicle is positioned in the facility or at the parking area in the facility. When the result of the determination is affirmative, the process proceeds to Step S310. When the result of the determination is negative, the process terminates without starting the facility exit guidance.

At Step S310, the process acquires the name of an exit area directed to the guided route. When the vehicle travels from its current position to the destination along the guided route, for example, the process uses the area signpost data to acquire the name of an area indicated on the first area signpost installed on the road. Alternatively, the process uses administrative district data to identify administrative districts where the guided route passes. Of these administrative districts, the process detects an administrative district adjacent to the administrative district where the vehicle is positioned. The process acquires the name of the former administrative district and assumes the name to be the exit area name.

At Step S330, the process determines whether or not the exit area name is acquired at Step S310. When the result of the determination is affirmative, the process provides the exit area name at Step S340. For example, the process outputs a message using a screen display on the display device 10 or audio (e.g., “go to the exit to the Kariya area.”) The process continuously provides the guidance until the vehicle exits from the facility or the parking area in the facility.

Even when the facility data does not contain the facility doorway position, there may be provided a signpost or a signboard indicating the exit area name in the facility, for example. In such case, the user can follow the guided route in accordance with the instruction of the signpost or the signboard that matches the administrative district or area name acquired at Step S310.

When the result of the determination at Step S330 is negative, the process determines whether or not the vehicle is positioned in a multi-level parking structure. When the result of the determination is affirmative, a slope entry point guidance process at Step S360 is performed. When the result of the determination is negative, an exit direction guidance process at Step S370 is performed.

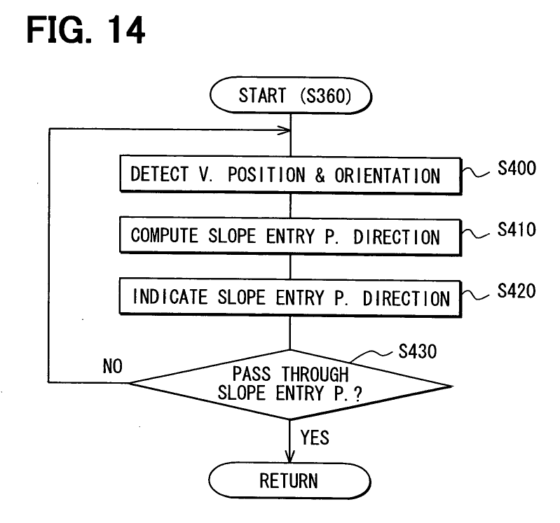

The slope entry point guidance process in FIG. 14 detects the vehicle position and the vehicle orientation (vehicle's traveling direction) at Step S400. At Step S410, the process uses approach road data and parking area map data of the parking area data to define a temporary exit point (slope entry point). The slope entry point corresponds to a node nearest to the vehicle position on the approach road when the vehicle exits from the floor where the vehicle is positioned. Using the list in FIG. 9B, the process calculates the relative or absolute direction of the slope entry point with reference to the vehicle's traveling direction.

At Step S420, the process outputs a message using a screen display on the display device 10 or audio (e.g., “the exit is backward” or “the exit is to the south.”) This step aims at notifying the user of the slope entry point direction calculated at Step S410. In this manner, the user can recognize the direction of the approach road for exiting from the floor where the vehicle is positioned.

At Step S430, the process determines whether or not the vehicle passes through the slope entry point. When the result of the determination is affirmative, the process terminates. When the result of the determination is negative, the process returns to Step S400 and repeats the succeeding steps.

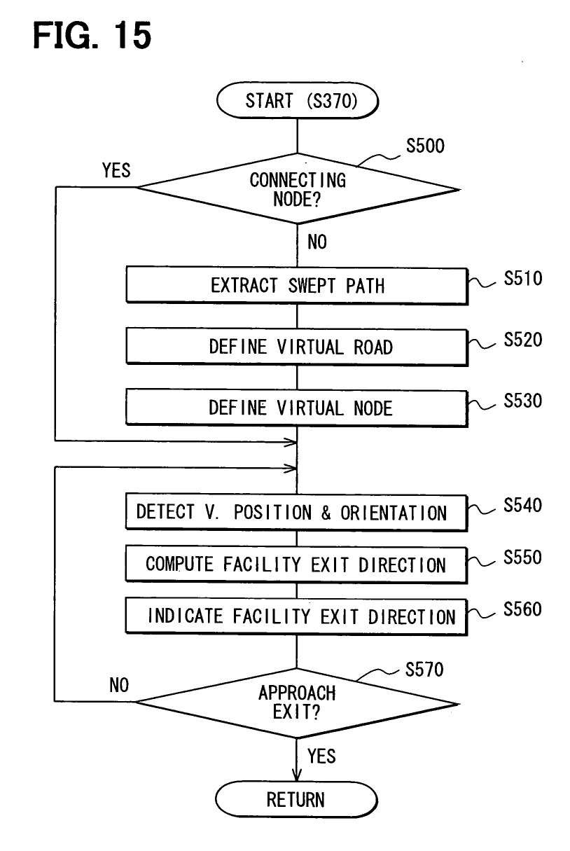

FIG. 15 shows the exit direction guidance process. At Step S500, the process determines whether or not there is available a node connecting between the road in the facility where the vehicle is positioned and the road outside the facility. When the result of the determination is affirmative, the process defines the node as the facility exit guidance point and the process proceeds to Step S540. When the result of the determination is negative, the process proceeds to Step S510.

At Step S510, the process extracts a vehicle's swept path from the external memory 9. The vehicle's swept path ranges from the general road outside the facility to the parking position in the facility. At Step S520, the process virtually defines the road in the facility from the vehicle's swept path. At Step S530, the process defines as a virtual node a point where the vehicle's swept path departs from a link or node for the general road outside the facility. The process defines the virtual node as the facility exit guidance point.

At Step S540, the process detects the vehicle position and the vehicle orientation (vehicle's traveling direction). At Step S550, the process calculates the exit direction with reference to the vehicle's traveling direction. At Step S560, the process outputs a message using a screen display on the display device 10 or audio. This step aims at notifying the user of the relative or absolute exit direction calculated at Step S550. At Step S570, the process determines whether or not the vehicle approaches the facility exit guidance point. When the result of the determination is affirmative, the process terminates. When the result of the determination is negative, the process returns to Step S540 and repeats the succeeding steps. Similarly to the third embodiment, the exit branch guidance may be performed after the result of the determination is affirmative at Step S570.

According to the above-mentioned embodiments, the map data is stored on recording media such as DVD-ROM and CD-ROM mounted on the map data input device 6. Further, it may be preferable to deliver part or all of the map data via a communication line. In this case, facility data contained in the map data may be updated as needed to increase the proportion of the facility data containing on-site passage data.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A navigation system provided in a vehicle, the system comprising:
map data storage means for storing map data on a map, the map data including (i) facility data on a position of a facility and a site of the facility and (ii) road data on a road outside the facility;
vehicle position detection means for detecting a vehicle position of the vehicle;
point storage means for storing, as a certain point, one of (i) an entering point where the vehicle position moves from a road outside the facility into the facility and (ii) an exiting point where the vehicle position moves from within the facility to a road outside the facility;
facility inside determination means for determining whether or not the vehicle position is in a facility; and
exit designation means for, when the vehicle position is determined to be in a facility, designating the certain point stored in the point storage means as an exit, through which the vehicle is able to exit from within the facility to a road outside the facility.

2. The navigation system according to claim 1, further comprising:
route retrieval means for calculating a route from an exit designated by the exit designation means to a user-designated destination; and
route guidance means for performing a route guidance along the calculated route.

3. The navigation system according to claim 1,
wherein, when a route guidance to the facility is performed, the point storage means stores as the certain point a point where the route guidance terminates.

4. The navigation system according to claim 1, further comprising:
exit guidance means for performing guidance of a direction of an exit designated by the exit designation means.

5. The navigation system according to claim 1, further comprising:
traveling direction detection means for detecting a traveling direction of the vehicle; and
exit guidance means for performing a guidance of a direction of an exit designated by the exit designation means in accordance with a traveling direction detected by the traveling direction detection means.

6. The navigation system according to claim 5, further comprising:
route retrieval means for calculating a route from an exit designated by the exit designation means to a user-designated destination,
wherein the exit guidance means further performs a guidance of a direction to depart from an exit designated by the exit designation means to a route retrieved by the route retrieval means.

7. The navigation system according to claim 5, further comprising:
route retrieval means for calculating a route from an exit designated by the exit designation means to a user-designated destination,
wherein the exit guidance means acquires and indicates a name of an area, toward which a route retrieved by the route retrieval means travels from an exit designated by the exit designation means.

8. The navigation system according to claim 1,
wherein, when facility exit information is included in facility data stored in the map data storage means, the exit designation means designates an exit based on the facility data.

9. The navigation system according to claim 1,
wherein, when the point storage means stores both (i) an entering point where the vehicle position moves from a road outside the facility into the facility and (ii) an exiting point where the vehicle position moves from within the facility to a road outside the facility, wherein both the entering point and the exiting point differ from each other, the exit designation means designates the exiting point as an exit.

10. The navigation system according to claim 1, comprising:
parking structure inside determination means for determining whether or not the vehicle is positioned inside a multi-level parking structure; and
temporary exit point definition means for, when the parking structure inside determination means determines that the vehicle is positioned inside a multi-level parking structure in a facility, defining a temporary exit point corresponding to an approach road exiting from a floor where the vehicle is positioned,
wherein, when the parking structure inside determination means determines that the vehicle is positioned inside a multi-level parking structure, the exit designation means designates the temporary exit point as an exit.

11. A method used in a navigation system in a vehicle,
the navigation system including
a map data storage unit that stores map data on a map, the map data including (i) facility data on a position of a facility and a site of the facility and (ii) road data on a road outside the facility, and
a vehicle position detector used to detect a vehicle position of the vehicle,
the method comprising:
storing, as a certain point, one of (i) an entering point where the vehicle position moves from a road outside the facility into the facility and (ii) an exiting point where the vehicle position moves from within the facility to a road outside the facility;
determining whether or not the vehicle position is in a facility; and
designating the certain point as an exit when the vehicle position is determined to be in a facility, the exit through which the vehicle is able to exit from within the facility to a road outside the facility.

12. A navigation system provided in a vehicle, the system comprising:
a map data storage unit that stores map data on a map, the map data including (i) facility data on a position of a facility and a site of the facility and (ii) road data on a road outside the facility;
a vehicle position detector used to detect a vehicle position of the vehicle;
a point storage unit that stores, as a certain point, one of (i) an entering point where the vehicle position moves from a road outside the facility into the facility and (ii) an exiting point where the vehicle position moves from within the facility to a road outside the facility;
a facility inside determination unit that determines whether or not the vehicle position is in a facility; and
an exit designation unit that designates the certain point as an exit when the vehicle position is determined to be in a facility, the exit through which the vehicle is able to exit from within the facility to a road outside the facility.
